(19) United States
(12) Patent Application Publication
(10) Pub. No.: US 2026/0258257 A1
(43) Pub. Date: Sep. 3, 2026

(54) COATING SYSTEM

(71) Applicant: JOTUN A/S, Sandefjord (NO)

(72) Inventors: Pengpeng WANG, Wuxi (CN); Jakob Stensgaard DIGET, Sandefjord (NO)

(21) Appl. No.: 18/879,601

(22) PCT Filed: Jul. 5, 2023
(86) PCT No.: PCT/EP2023/068629

§ 371 Date: Dec. 27, 2024

(30) Foreign Application Priority Data
Jul. 5, 2022 (WO) PCT/CN2022/103901
Jul. 26, 2022 (EP) 22187074.4

(51) Int. Cl. C09D 5/08; C09D 175/12; F03D 1/06

(52) U.S. Cl. CPC C09D 5/08; C09D 175/12; F03D 1/0688; F05B 2230/90; F05B 2280/6011

(57) ABSTRACT

The invention relates to coating system comprising at least two layers A and B, wherein said layers A and B are adjacent and wherein layer A comprises: (A) A tiecoat composition comprising: (i) A first component comprising at least one polyol resin; and (ii) A second component comprising an isocyanate compound; and wherein layer B comprises: (B) A leading edge protection (LEP) coating composition comprising: a) a first component comprising at least one polymer selected from the group consisting of polyols, polyaspartic esters, polyetheraspartic esters and mixtures thereof; and b) a second component comprising at least one polyisocyanate curing agent.

### FIELD OF THE INVENTION

This invention relates to coating systems, in particular to a coating system for wind turbine blades, especially the leading edge of wind turbine blades. The coating system comprises a tiecoat composition and a leading edge protection (LEP) coating composition. The invention further relates to substrates, in particular wind turbine blades, coated with the coating system and to the use of the coating system in coating substrates, such as wind turbine blades.

### BACKGROUND

A common challenge for the wind turbine industry is the wear and erosion of the wind turbine blades due to the high velocity at the tip of the blade combined with the collision of rain droplets and particulate material, such as dust or sand. A whirling arm Rain Erosion test (RET) rig is typically used to test durability.

Leading-edge protection (LEP) is applied to protect the peripheral part of the blade (leading edge) with the highest speed of rotation (often more than 300 km hr⁻¹). Typical coating systems for LEP comprise at least one basecoat (e.g. polyurethane or polyaspartic) and an LEP coating. In some cases, a further topcoat is applied on top of the LEP coating. Adhesion is crucial in obtaining good RET performance, particularly for leading edge protection. Often, however, the LEP fails as a result of peel-off of the LEP coating from the substrate (glass-reinforced plastic also called glass fiber reinforced polymer, GRP), filler, or the basecoat (typically polyurethane or polyaspartic).

It is thus an object of the present invention to provide an improved coating system which possesses both good erosion resistance and adhesion to at least one of the substrates, fillers or basecoats described above. It is also desirable to provide a coating system which has good storage stability and/or shelf life. The present inventors have surprisingly found that a system comprising a particular tiecoat layer and a LEP coating layer offers an attractive solution.

### SUMMARY

Thus, in a first aspect, the invention provides a coating system comprising at least two layers A and B, wherein said layers A and B are adjacent and wherein layer A comprises:
(A) A tiecoat composition comprising:
   (i) A first component comprising at least one polyol resin; and
   (ii) A second component comprising an isocyanate compound; and
      wherein layer B comprises:
(B) A leading edge protection (LEP) coating composition comprising:
   a) a first component comprising at least one polymer selected from the group consisting of polyols, polyaspartic esters, polyetheraspartic esters and mixtures thereof; and
   b) a second component comprising at least one polyisocyanate curing agent.

In a second aspect, the invention provides a coating system comprising at least two layers A and B, wherein said layers A and B are adjacent and wherein layer A comprises:
(A) A tiecoat composition comprising:
   (i) A first component comprising at least one polyol resin; and
   (ii) A second component comprising an isocyanate compound,
   wherein the first and second components have been mixed and cured; and
      wherein layer B comprises:
(B) A leading edge protection (LEP) coating composition comprising:
   a) a first component comprising at least one polymer selected from the group consisting of polyols, polyaspartic esters, polyetheraspartic esters and mixtures thereof; and
   b) a second component comprising at least one polyisocyanate curing agent,
   wherein the first and second components have been mixed and cured.

It is preferred if the polyol resin is an epoxy resin, such as a bisphenol A epoxy resin, wherein the number average molecular mass (Mn) of the epoxy resin as polyol resin (i) in (A) is at least 3000 g mol⁻¹, preferably at least 3500 g mol⁻¹;
or the polyol resin is a phenol formaldehyde resin, preferably a novolac resin.

In a third aspect, the invention provides a substrate at least partly coated with a coating system as hereinbefore defined.

In a further aspect, the invention provides the use of a coating system as hereinbefore defined for coating at least part of a substrate, wherein the substrate is preferably a wind turbine blade, more preferably the leading edge of a wind turbine blade.

In another aspect, the invention provides a process for coating at least part of a substrate with a coating system as hereinbefore defined, said process comprising applying the tiecoat composition (A) to the surface of said substrate and allowing said composition (A) to cure, and subsequently applying the LEP coating composition (B) directly on top of said composition (A), and allowing said composition (B) to cure.

### Definitions

A leading-edge protection (LEP) coating is used herein to refer to a coating which is applied to protect the peripheral part of the blade (leading edge) with the highest speed of rotation (often more than 300 km hr⁻¹). Primer, mid-coat, topcoat and tiecoat, are all well-known terms in the art.

By “epoxy resin” we mean any polymer which contains one or more epoxide moieties.

As used herein, equivalent weight pertains to the mass in grams of a reactive compound having a number of reactive groups equivalent to 1 mol. For epoxy resin based binders the equivalent weight is denoted epoxy equivalent weight (EEW). Thus, the contribution from each of the epoxy-based binders, or other epoxy functional components, to the number of epoxy equivalents in the composition is defined as grams of epoxy-based compound divided by the epoxy equivalent weight of the epoxy-based compound.

Where “molecular weight” is quoted for a particular component, we refer to the theoretical value for the molecular weight of the ideal molecule. It is typically used for small molecules.

Where “number average molecular weight (Mₙ)” is quoted for a particular component (typically a polymeric component) we mean the total weight divided by the total number of molecules. Mₙ is a value obtained analytically, e.g., via end-group analysis or gel permeation chromatography (GPC).

By “curing” in the context of the present invention, it is meant a process in which a solid layer of the coating system is obtained from the liquid components. The curing may take place, for example, via a chemical reaction and/or via evaporation of solvent. It will be understood that the curing reaction may not always be complete, for example, there may be unreacted functional groups, such as isocyanate groups, remaining after “curing” has taken place. Thus, by “curing”, “cured” or “allowing to cure” we cover both the scenarios of partial and complete curing.

### DETAILED DESCRIPTION

The invention relates to a coating system comprising at least two layers A and B, wherein said layers A and B are adjacent and wherein layer A comprises a tiecoat composition (A) and layer B comprises a leading edge protection (LEP) coating composition (B). The coating composition comprises at least two layers and it follows therefore that layers A and B are different.

### Tiecoat Composition (A)

The tiecoat composition (A) forms layer A of the coating system. Layer A may thus be termed a tiecoat layer. The term “tiecoat layer” in the context of the invention means a layer of a coating system which acts as a bridge between, for example, a substrate or a primer or undercoat layer and an adjacent LEP coating layer. It will thus be understood that the tiecoat layer A does not form the outermost layer of the coating system. Similarly, therefore, the tiecoat composition (A) of the invention is not employed as the outermost composition in the coating system.

The tiecoat composition (A) comprises a first component (i) comprising at least one polyol resin and a second component (ii) comprising at least one isocyanate compound. In one embodiment of the invention, the first and second components have been mixed and cured.

### First (Polyol) Component (i)

The first component comprises at least one polyol resin. The polyol resin is a hydroxy functional compound (i.e. a compound comprising hydroxyl functional groups which may be disguised as epoxy groups). Preferably the polyol is a high molecular weight polyol, more preferably comprising aromatic segments in the backbone of the polymer structure. Preferably the Mₙ of the polyol is at least 1500 g mol⁻¹, more preferably at least 2000 g mol⁻¹, even more preferably at least 3500 g mol⁻¹. Values up to 20,000 g/mol are possible, such as 15,000 g/mol.

Whilst it is within the ambit of the invention for more than one polyol resin to be present, preferably only a single polyol resin is used.

In one aspect the polyol resin comprises a bisphenol type compound. Examples of such are the diglycidyl ether of bisphenol A (BADGE) or the diglycidyl ether of bisphenol F, such resins are commonly known as epoxy resins. Bisphenol A is preferred. Preferably the resin is solid at ambient conditions. Preferable epoxy resins are Epoxy type 8 or 9, most preferably type 9. Preferably the Mₙ is at least 1500 g mol⁻¹, more preferably at least 2000 g mol⁻¹, more preferably at least 3000 g mol⁻¹

Epoxy resins are typically characterized by their epoxy equivalent weight (EEW). The (solid) resin ideally has an EEW of 1100-7000 g eq⁻¹, preferably 2000-5000 g eq⁻¹. The epoxy resins suitable for application in the present invention typically have a hydroxyl equivalent weight (OHEW) of 305-293.

The epoxy resin (e.g. solid epoxy resin) may have a softening point of 100-180° C., preferably 120-160° C., e.g. 130-150° C., when determined in accordance with ASTM D 3104.

The epoxy resin (e.g. solid epoxy resin) may have a kinematic viscosity as solution with 40% weight solid content in diethylene glycol monobutyl ether of 1000-10000 cSt, preferably 1000-8000 cSt, when determined in accordance with ASTM D 445.

Examples of suitable commercially available bisphenol A epoxy resins are YD-017H, KD-2119, YD-019, YD-019K, YP-50, YP-55 and YP-70 from Kukdo Chemical Co., D.E.R. 668-20, D.E.R. 669-20 and D.E.R. 669E from Olin.

In another aspect, the polyol resin may comprise a phenolic-type resin synthesized from a phenol (e.g. an unsubstituted phenol or vinylphenol) and/or derivatives thereof, such as (but not limited to) resorcinol, m-cresol, 2,3-xylenol, cardanol and cardol, and an aldehyde. Preferably, in this embodiment, the resin is a phenol formaldehyde type resin (a novolac resin). The novolac resin may also be an at least partially reacted mixture of a 1) carbamic resin derived from n-butyl carbamate and formaldehyde, and 2) a phenol novolac derived from phenol and formaldehyde. A suitable mixture of carbamic resin and phenol novolac is available as Alnovol PN760 from Allnex.

The novolac resin typically has a molecular weight of at least 500 g mol⁻¹, and a softening point of 90-130° C. Examples of a suitable commercially available novolac resin include Alnovol PN320/PAST from Allnex and those available from SBHPP. Particularly suitable phenolic-type resins include high molecular weight resins, e.g. those having Mₙ>1000 g mol⁻¹

The polyol resin(s) of the invention are curable by reaction with a curing agent reactive towards hydroxyl-groups (OH-groups). By “curable” it is meant that the resins contain reactive OH-groups which are capable of reacting with an isocyanate compound and form a cured or cross-linked polymer.

The polyol resin(s) is typically present in an amount of 10 to 95 wt %, relative to the total weight of the first (polyol) component (i) as a whole. Preferably, the polyol resin(s) form more than 90 wt % (dry), relative to the dry weight (i.e. excluding solvents) of the first (polyol) component (i).

The polyol resin(s) is usually present in an amount of 5 to 50 wt %, preferably 10 to 30 wt %, relative to the total weight of the tiecoat composition (A). Preferably, the polyol resin(s) form 10 to 90 wt % (dry), more preferably 30 to 80 wt %, e.g. 60-75 wt % (dry) relative to the dry weight (i.e. excluding solvents) of the tiecoat composition (A).

Where more than one polyol resin is present it will be understood that these figures refer to the total amount of all polyol resins present in the tiecoat composition (A).

### Second Component (ii): Isocyanate Compound

The isocyanate compound may be any suitable compound comprising at least one isocyanate functional group. A single isocyanate compound, or a mixture of more than one isocyanate compound may be used.

The number of isocyanate groups per molecule is readily determinable via the isocyanate content and the Mₙ of the respective polyisocyanate. The isocyanate content, in wt %, can be determined, for example, in accordance with DIN EN ISO 11909 by reaction of the respective sample with excess dibutylamine and back-titration of the excess with hydrochloric acid against bromophenol blue.

In a preferred embodiment, the isocyanate compound comprises, e.g. consists of, a polyisocyanate. Preferred polyisocyanates are solvent-free and are substantially free of isocyanate monomer, e.g. contains less than 0.5% of isocyanate monomer as measured according to DIN EN ISO 10283.

In the context of the present invention, it is possible to use aliphatic, cycloaliphatic or aromatic polyisocyanates, such as hexamethylene diisocyanate (HDI), trimethylhexamethylene diisocyanate, 1,5-pentamethylene diisocyanate (PDI), 4,4′-diisocyanato dicyclohexylmethane (H₁₂MDI), 2,2-, 2,4-, 2,6-diphenylmethane diisocyanate (MDI), 2,4-, 2-6-tolylidene diisocyanate (TDI), 1-isocyanato-3,3,5-trimethyl-5-isocyanatomethylcyclohexane (isophorone diisocyanate, IPDI), 4,4′-diisocyanatodicyclohexylmethane, o-, m- and p-xylylene diisocyanate, 4,4′-diisocyanatodiphenylmethane, 1,5-pentamethylene diisocyanate (PDI); and also, for example, polyisocyanates containing biuret, allophanate, urethane or isocyanurate groups.

Preferably the polyisocyanate is aromatic or aliphatic, or a combination thereof. Aliphatic isocyanates are preferably silane-functional or HDI trimers.

Most preferably, the polyisocyanate comprises (e.g. consists of) an aromatic polyisocyanate, e.g. TDI or MDI.

The polyisocyanate can be in any form, including but not limited to, dimer, trimer, isocyanurate, adducts, polymeric and prepolymer isocyanate.

The isocyanate (NCO) content of the polyisocyante is preferably 5-35 wt % on supply form.

The molecular weight of the polyisocyanate is preferably between 200 and 3,000 g mol⁻¹

The functionality of the polyisocyanate (i.e. the number of isocyanate groups present per molecule) may range from 2 to 10, e.g. 2 to 5.

Polyisocyanates for use in the invention can be purchased commercially. Commercial suppliers include Covestro, BASF, Asahi Kasei, Wanhua, and Vencorex, and suitable polyisocyanates are sold under trade names such as Desmodur, Duranate, Tolonate, Wannate, and Basonate.

The isocyanate compound in component (ii) is preferably present in the tiecoat composition (A) of the invention in a range of 2 to 50 wt %, more preferably 10 to 45 wt %, such as 12 to 40 wt %, e.g. 15 to 35 wt %, relative to the total weight of the tiecoat composition (A). Preferably, the isocyanate compound(s) form 10-90 wt % (dry), more preferably 20-80 wt % (dry) even more preferably 30 to 60 wt % (dry), relative to the dry weight (i.e. excluding solvents) of the tiecoat composition (A).

Preferably, the isocyanate(s) constitutes more than 90 wt % (dry) relative to the dry weight (i.e. excluding solvents) of component (ii) of the tiecoat composition.

It will be appreciated that where more than one isocyanate compound is present, the hereinbefore quoted wt % ranges relate to the total amount of all isocyanate compounds employed. In one embodiment, a single isocyanate compound is used. In an alternative embodiment, a mixture of two or more isocyanate compounds is used.

The NCO to amine and hydroxyl (NH+OH) ratio based on moles (or number of functional groups) of the total tiecoat composition on solids (i.e., excluding solvents) is preferably 0.4-1.1, preferably 0.6-1.0, most preferably 0.7-0.9, such as 0.8. The NCO to hydroxyl (OH) ratio based on moles (or number of functional groups) of the total tiecoat composition on solids (i.e., excluding solvents) is preferably 0.4-1.1, preferably 0.6-1.0, most preferably 0.7-0.9, such as 0.8. These ratios are especially preferred wherein the first (polyol) component (i) is bisphenol A.

### Other Components

The tiecoat composition (A) of the present invention may also include other substances commonly used in coating formulations such as fillers, pigments, matting agents, solvents and additives such as waxes, dyes, dispersants, wetting agents, defoamers, surfactants, adhesion promoters, light stabiliser, water scavengers and thixotropic agents.

In one particular embodiment, the tiecoat composition (A) comprises an adhesion promoter.

Examples of suitable adhesion promotors include alkoxy silanes such as those known under the tradename Dynasylan from Evonik, for example Dynasylan AMEO and Dynasylan 1189, and known as Silquest from Momentive such as A1524 (similar to VPS 2101 from Evonik, 3-ureidopropyltrimethoxysilane), and NCO-alkoxysilane hybrids such as Desmodur® 2873 from Covestro. Dynasylan GLYMO, Dynasylan GLYE, Dynasylan AMMO, and Dynasylan DAMO may also be used.

Examples of extenders are minerals such as dolomite, quartz, barite, silica, wollastonite, talc, mica, kaolin, and feldspar; synthetic inorganic compounds such as calcium carbonate, barium sulphate, polymeric and inorganic microspheres. Preferably the tiecoat composition/layer does not contain any extender.

Pigments of interest include organic pigments and inorganic pigments.

Examples of suitable solvents and diluents include solvents that are unreactive towards isocyanate groups. Suitable solvents are esters, such as ethyl acetate, isopropyl acetate, n-butyl acetate, t-butyl acetate, methyl glycol acetate (2-methoxyethyl acetate), ethyl glycol acetate (2-ethoxyethyl acetate), butyl glycol acetate (2-butoxyethnol acetate), n-butanol, i-butanol, t-butanol, 2-butanol, benzyl alcohol, i-propanol, n-propanol, 2-propanol, 1-methoxy-2-propyl acetate (PMA glycol ether), ethers such as tetrahydrofuran, dioxane, ketones such as acetone, 2-butanone (methyl ethyl ketone), 4-methyl-2-pentanone (methyl isobutyl ketone, MIBK), 2-hexanone, 5-methyl-2-hexanone, 2-heptanone, cyclohexanone, cyclopentanone, hydrocarbons, aromatic hydrocarbons such as benzene, toluene, xylene or ethylbenzene, halogenated hydrocarbons such as chlorobenzene, methylene chloride, trichloromonofluoroethane, p-chlorobenzotrifluoride, and mixtures of the above mentioned solvents. Preferred solvents are esters such as ethyl acetate, n-butyl acetate, t-butyl acetate, 1-methoxy-2-propyl acetate, and xylene and ketones such as methyl isobutyl ketone and methyl ethyl ketone.

Solvent preferably makes up 20 to 90 wt % of the tiecoat composition (A) as a whole. It will be appreciated that the wt % ranges for the solvent are relative to the tiecoat composition (A) before curing (i.e. before the coating is cured and dried). Any pigments preferably make up 1 to 30 wt %, e.g. 15 to 25 wt % of the tiecoat composition (A) as a whole. Additives typically in total make up less than 10 wt % relative to the total weight of the tiecoat composition (A) as a whole. Extenders typically preferably make up 0-40 wt % relative to the total weight of the tiecoat composition (A) as a whole.

Preferably any extenders and additives are added in the polyol resin component (i). Pigments may be added to any or both of component (i) or (ii).

### Leading Edge Protection (LEP) Coating Composition (B)

The term “LEP coating composition” (B) in the context of the invention means the composition which forms layer B of the coating system and is applied adjacent to the tiecoat composition (A). It will be understood that LEP layer B is an outer layer relative to the tiecoat layer. Most often the LEP layer (B) forms the outermost layer of the coating system as a whole, but sometimes the LEP layer (B) may be coated with another top coat layer. Layer B may be termed a LEP layer.

The LEP coating composition of the invention comprises a first component a) comprising at least one polymer selected from the group consisting of polyols, polyaspartic esters, polyetheraspartic esters and mixtures thereof; and a second component b) comprising at least one polyisocyanate curing agent. In one embodiment of the invention, the first and second components have been mixed and cured.

### First Component a)

The first component a) of the LEP coating composition (B) comprises at least one polymer selected from the group consisting of polyols, polyaspartic esters, polyetheraspartic esters and mixtures thereof.

Examples of suitable polyols are polyester polyols, polyacrylic polyols, polyether polyols, and polycarbonate polyols. It is preferred if the first component is not an epoxy resin.

By “polycarbonate polyol” we mean any polycarbonate polymer which contains two or more hydroxyl moieties. In all embodiments of the invention, it is preferable if the polycarbonate polyol is a diol, i.e. contains two hydroxyl functional groups. More preferably, the two hydroxyl functional groups are terminal groups on the polymer chain, i.e. one at each end of the polymer chain.

Preferably, the polycarbonate polyol comprises a repeating unit with the following structure:

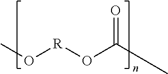

wherein
R is selected from the group consisting of linear or branched C₁₋₂₀ alkyl groups, C₃₋₁₂ cycloalkyl groups, and optionally substituted C₆₋₂₀ aryl groups; and
n is an integer from 2 to 50.

Preferably, R is a linear or branched C₁₋₂₀ alkyl group. The term “alkyl” is intended to cover linear or branched alkyl groups such as propyl, butyl, pentyl and hexyl. It will be understood that the “alkyl” group in the context of the polycarbonate is divalent and thus may also be referred to as “alkylene”. Particularly preferable alkyl groups are pentyl and hexyl. In one particularly preferred embodiment, R is hexyl. In all embodiments, the alkyl group is preferably linear.

In one embodiment, only a single (i.e. one type of) repeating unit is present. In an alternative embodiment, more than one, e.g. two, different repeating units are present. If different repeating units are present they may have a random or a regular distribution within the polycarbonate polyol. It will be understood that where more than one repeating unit is present, these repeating units will contain different R groups. In one preferable embodiment, two repeating units are present, in the first R is pentyl and in the second R is hexyl.

Particularly preferred cycloalkyl groups include cyclopentyl and cyclohexyl.

Examples of the substituted aryl groups include aryl groups substituted with at least one substituent selected from halogens, alkyl groups having 1 to 8 carbon atoms, acyl groups, or a nitro group. Particularly preferred aryl groups include substituted and unsubstituted phenyl, benzyl, phenylalkyl or naphthyl.

It is preferable if R does not contain a hydroxyl functional group.

Preferably, n is an integer in the range 2 to 25, such as 2 to 20, e.g. 2 to 15.

The functionality of the polycarbonate polymer (i.e. the number of hydroxyl groups present per molecule) may range from 2 to 10. Preferably, the functionality is 2.

The polycarbonate polyols of the invention preferably have a hydroxyl number of 50-250, such as 60-120 mg KOH/g.

The viscosity at 40° C. of the polycarbonate polyol may range from 10 mPa·s to 10,000 mPa·s, such as 50 mPa·s to 5,000 mPa·s, especially 300 mPa·s to 4,000 mPa·s.

Preferably, the polycarbonate polyol is amorphous.

The softening point of the polycarbonate polyol is preferably below 0° C.

Polycarbonates for use in the invention can be purchased commercially. Commercial suppliers include Bayer, UBE and Asahi Kasei and suitable polycarbonates (i) are sold under trade names such as Duranol, Eternacoll and Desmophen. Particular examples of suitable commercially available polycarbonates are Duranol T5651, Desmophen C1100, Demophen C XP 2716, Eternacoll PH-100 and Eternacoll PH-50.

By “polyacrylic polyol” we mean any polyol which is prepared from two or more (meth)acrylate monomers and/or (meth)acrylamide monomers, and it may also contain vinyl monomers. Moreover, the polyacrylic polyol contains at least two hydroxyl functional groups.

The polyacrylic polyol is not particularly restricted but may be any polyacrylic polyol having reactivity with a polyisocyanate and examples thereof may include compounds obtained by polymerization of a mixture of unsaturated monomers selected from unsaturated monomers containing a hydroxyl group, unsaturated monomers containing an acid group, unsaturated monomers containing an amine group and other unsaturated monomers.

The above-mentioned unsaturated monomers containing a hydroxyl group are not particularly restricted and examples thereof may include hydroxyethyl acrylate, hydroxyethyl methacrylate, hydroxypropyl methacrylate, hydroxybutyl acrylate, Placcel FM-1 (manufactured by Daicel Chemical Industries; &-caprolactone-modified hydroxyethyl methacrylate), polyethylene glycol monoacrylate or monomethacrylate, and polypropylene glycol monoacrylate or monomethacrylate.

The above-mentioned unsaturated monomers containing an acid group are not particularly restricted and examples thereof may include carboxylic acids such as acrylic acid, methacrylic acid, itaconic acid, crotonic acid, and maleic acid.

The above-mentioned other unsaturated monomers are not particularly restricted and examples thereof may include acrylic monomers containing an ester group such as methyl acrylate, ethyl acrylate, propyl acrylate, butyl acrylate, hexyl acrylate, ethylhexyl acrylate, or lauryl acrylate or methacrylate esters; vinylalcohol ester type monomers such as esters of carboxylic acids, e. g. acetic acid and propionic acid with vinyl alcohol; unsaturated hydrocarbon monomers such as styrene, α-methylstyrene, vinylnaphthalene, butadiene, and isoprene; nitrile type monomers such as acrylonitrile and methacrylonitrile; and acrylamide type monomers such as acrylamide, methacrylamide, N-methylolacrylamide, N,N-dimethylacrylamide, and diacetoneacrylamide.

In one embodiment, the polyacrylic polyol is one comprising the following repeating unit:

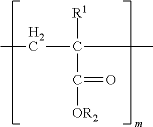

wherein R¹ and R² may be the same or different and are each independently selected from the group consisting of hydrogen, linear or branched C₁₋₂₀ alkyl groups, linear or branched hydroxy C₁₋₂₀ alkyl groups, C₃₋₁₂ cycloalkyl groups, and optionally substituted C₆₋₂₀ aryl groups; and
m is an integer from 2 to 50.

Preferably, R¹ and R² are each independently hydrogen, a linear or branched C₁₋₂₀ alkyl group or a linear or branched hydroxy C₁₋₂₀ alkyl. The term “alkyl” is intended to cover linear or branched alkyl groups such as methyl, ethyl, propyl, butyl, pentyl and hexyl.

Preferably, R¹ is hydrogen or C₁₋₆ alkyl, e.g. methyl.

Preferably, R¹ is hydrogen, C₁₋₆ alkyl or hydroxyC₁₋₆ alkyl.

Particularly preferred cycloalkyl groups include cyclopentyl and cyclohexyl.

Examples of the substituted aryl groups include aryl groups substituted with at least one substituent selected from halogens, C₁₋₈ alkyl groups, acyl groups, or a nitro group. Particularly preferred aryl groups include substituted and unsubstituted phenyl, benzyl, phenalkyl or naphthyl.

Preferably, m is an integer in the range 2 to 25, such as 2 to 20, e.g. 2 to 15. The above represented repeating unit, and preferable embodiments thereof, may also be applicable wherein the polyacrylic polyol comprises (meth)acrylamide monomers. In such embodiments, it will be appreciated that the OR² in the repeating unit will instead be NHR². Furthermore, the above represented repeating unit, and preferable embodiments thereof, may also be applicable wherein the polyacrlyic polyol comprises vinylalcohol ester type monomers. In such embodiments, it will be appreciated that the —(C—O)—OR² group will instead be simply an R² group.

In one embodiment, only a single (i.e. one type of) repeating unit is present. In an alternative embodiment, more than one, e.g. two, different repeating units are present. If different repeating units are present they may have a random or a regular distribution within the polyacrylic polyol. It will be understood that where more than one repeating unit is present, these repeating units will differ in at least one of R¹ and R².

The Mₙ of the polyacrylic polyol is preferably between 200 and 20,000 g mol⁻¹.

The functionality of the polyacrylic polyol (i.e. the number of hydroxyl groups present per molecule) may range from 2 to 10. The polyacrylic polyols of the invention preferably have a hydroxyl number of 50-250 mg KOH/g, such as 75-180 mg KOH/g calculated on solids.

The viscosity at 23° C. of the polyacrylic polyol may range from 10 mPa·s to 20,000 mPa·s, such as 100 mPa·s to 15,000 mPa·s, especially 500 mPa·s to 12,000 mPa·s. The viscosity may be measured on the pure polyacrylic polyol or the polyacrylic polyol in solution. Preferably, the viscosity is measured for the polyacrylic polyol in butyl acetate, such as a 50-100 wt % of the polyacrylic polyol in butyl acetate, e.g. 75 wt % in butyl acetate.

Polyacrylic polyols for use in the invention can be purchased commercially. Commercial suppliers include Allnex, Arkema, Yoo-Point, Cytec, Covestro and Nuplex. Suitable polyacrylic polyols are sold under trade names such as Macrynol, Setalux, Synocure and Uracron, and particular examples of suitable commercially available polyacrylic polyols are Macrynal SM 2810/75BAC, Setalux 1914, Setalux 1907, Setalux 1909, Synocure 580 BA 75, Synocure 865 EEP 70, Uracron CY240 EF-75.

By “polyester polyol” we mean any polymer which contains more than one ester functional group. Moreover, the “polyester polyol” contains at least two hydroxyl functional groups. The functionality of the polyester polyol (i.e. the number of hydroxyl groups present per molecule) may range from 2 to 10. Preferably, the polyester polyol is one comprising the following repeating unit:

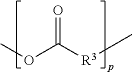

wherein R³ is selected from the group consisting of linear or branched C₁-20 alkyl groups, C₃₋₁₂ cycloalkyl groups, and optionally substituted C₆₋₂₀ aryl groups; and
p is an integer from 2 to 50.

Preferably, R³ is a linear or branched C₁-20 alkyl group. The term “alkyl” is intended to cover linear or branched alkyl groups such as propyl, butyl, pentyl and hexyl. Particularly preferable alkyl groups are pentyl and hexyl. In all embodiments, the alkyl group is preferably linear. It will be understood that the “alkyl” group in the context of the polyester polyol is divalent and thus may also be referred to as “alkylene”.

In one particularly preferred embodiment, R³ is C₁₋₆ alkyl.

Particularly preferred cycloalkyl groups include cyclopentyl and cyclohexyl.

Examples of the substituted aryl groups include aryl groups substituted with at least one substituent selected from halogens, alkyl groups having 1 to 8 carbon atoms, acyl groups, or a nitro group. Particularly preferred aryl groups include substituted and unsubstituted phenyl, benzyl, phenalkyl or naphthyl.

Preferably, p is an integer in the range 2 to 25, such as 2 to 20, e.g. 3 to 15.

The Mₙ of the polyester polyol is preferably between 200 and 20,000, such as 500 to 10,000.

The polyester polyols of the invention preferably have a hydroxyl number of 50-350, such as 100-300, e.g 150-300 mg KOH/g (calculated on solids).

The viscosity of the polyester polyol at 23° C. may range from 10 mPa·s to 20,000 mPa·s, such as 100 mPa·s to 15,000 mPa·s, especially 500 mPa·s to 10,000 mPa·s.

Polyester polyols for use in the invention can be purchased commercially. Commercial suppliers include Arkema, Covestro, DSM (now Covestro) and Nuplex and suitable polyester polyols are sold under trade names such as Setal, Desmophen, Synolac and Uralac. Particular examples of suitable commercially available polyester polyols are Setal 169 SS-67, Synolac 5086 and Uralac SY946.

In a preferred embodiment, the LEP coating composition (B) comprises at least one polymer selected from polyaspartic esters, polyetheraspartic esters and mixtures thereof. It is also possible for the LEP coating composition to comprise a mixture of two or more different polyaspartic esters and/or two or more different polyetheraspartic esters.

In one embodiment, the first component contains only one polyaspartic. Thus, in this embodiment, the polyaspartic consists of a polyaspartic ester or a polyetheraspartic ester, preferably a polyaspartic ester.

In an alternative embodiment, the first component comprises a mixture of at least one polyaspartic ester and at least one polyetheraspartic ester. In this embodiment, the weight ratio of the at least one polyaspartic ester to the at least one polyetheraspartic ester is preferably in the range 99:1 to 1:99, more preferably 75:25 to 25:75, even more preferably 50:50.

Any suitable polyaspartic ester may be used, however typically the polyaspartic ester is a polyaspartic ester comprising sterically hindered secondary amines and ester groups. Suitable polyaspartic esters are described in WO2016049104 A1.

The polyaspartic ester may include one or more polyaspartic esters corresponding to formula (I):

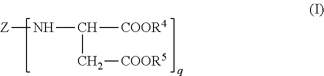

wherein: q is an integer of 2 to 6; Z represents an aliphatic residue; and R⁴ and R⁵ represent organic groups that are inert to isocyanate groups under reaction conditions and that may be the same or different organic groups.

In formula (I), the aliphatic residue Z may correspond to a straight or branched alkyl and/or cycloalkyl residue of an n-valent polyamine that is reacted with a dialkylmaleate in a Michael addition reaction to produce a polyaspartic ester. For example, the residue Z may correspond to an aliphatic residue from an n-valent polyamine including, but not limited to, ethylene diamine; 1,2-diaminopropane; 1,4-diaminobutane; 1,6-diaminohexane; 2,5-diamino-2,5-dimethylhexane; 2,2,4- and/or 2,4,4-trimethyl-,6-diaminohexane; 1,11-diaminoundecane; 1,12-diaminododecane; 1-amino-3,3,5-trimethyl-5-amino-methylcyclohexane; 2,4′- and/or 4,4′-diaminodicyclohexylmethane; 3,3′-dimethyl-4,4′-diaminodicyclohexylmethane; 2,4,4′-triamino-5-methyldicyclohexylmethane; polyether polyamines with aliphatically bound primary amino groups and having a Mₙ of 148 to 6000 g mol⁻¹; isomers of any thereof, and combinations of any thereof.

In certain embodiments, the residue Z may be obtained from 1,4-diaminobutane; 1,6-diaminohexane; 2,2,4- and/or 2,4,4-trimethyl-1,6-diaminohexane; 1-amino-3,3,5-trimethyl-5-aminomethylcyclohexane; 4,4′-diaminodicyclohexylmethane; 3,3′-dimethyl-4,4′-diaminodicyclohexylmethane; or 1,5-diamine-2-methyl-pentane.

In certain embodiments, the polyaspartic ester comprises one or more compounds corresponding to formula (I) in which q is an integer from 2 to 6, in some embodiments q is an integer from 2 to 4, and in some embodiments q is 2.

Examples of commercially available polyaspartic esters are Desmophen NH 1220, NH 1420, NH 1422, NH 1423, NH 1423 LF, NH 1520 NH 1521 and NH 1523 LF all from Covestro and F220, F221, F420, F421, F520 all from Feiyang, and IC20 and IC40 from Evonik.

Any suitable polyetheraspartic ester may be used, however typically the polyetheraspartic ester is one having the formula (II) below

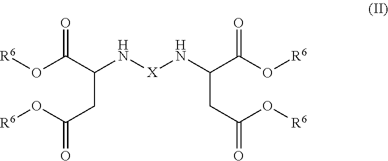

wherein each R⁶ represents a linear or branched C₁-C₁₀ alkyl residue, such as a linear or branched C₁-C₆ alkyl residue, such as for example a methyl, ethyl, propyl or butyl residue; and wherein X is a polyether.

In one embodiment, the invention relates to a first component comprising a blend of polyetheraspartic esters wherein X is a polyether having a repeat unit of the structure:

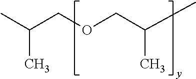

wherein y is in the range of 2 to 35.

The blend of polyetheraspartic esters may comprise at least two different polyetheraspartic esters which have a different number of repeating units in X. In one embodiment, the blend is such that the average value of y is in the range of 2 to 10, such as 2 to 6, such as 2 to 4, such as 2.5 to 3.

Polyetheraspartic esters may be prepared by reacting one or more polyether polyamines with a dialkylmaleate, such as for example a linear or branched C₁-C₁₀ dialkyl maleate, such a linear or branched C₁-C₆ dialkyl maleate, such as for example diethyl maleate. Said polyetheraspartic esters may be prepared, for example, by employing the reactants in amounts such that there is at least one equivalent, and in some embodiments approximately one equivalent, of olefinic double bonds for each equivalent of primary amino groups. Examples of methods for the preparation of polyetheraspartic esters can be found in WO 2014/151307 and in Chen et al., RSC Advances (2018), 8:13474-13481.

Suitable polyether polyamines that may be reacted with dialkylmaleates in Michael addition reactions to produce polyetheraspartic esters for the coating compositions of the invention include the JEFFAMINE polyetheramines commercially available from Fluntsman Corporation, The Woodlands, TX; for example polyetheramines from the Jeffamine D series, such as for example Jeffamine D-230.

In one embodiment, the blend of polyether polyamines comprises a blend of polyether polyamines according to formula (III) below,

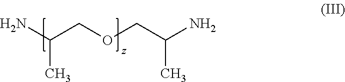

wherein z is a number having an average value of at least 2, such as 2 to 35, or 2 to 8, or 2.5 to 6.1 wherein the blend comprises: (1) about 50 to 99 wt %, such as 50 to 90% by weight, or, in some cases, 80 to 90 wt %, of polyether polyamines according to the formula wherein z has an average value of 2.5; and (2) about 1 to 50 wt %, such as 10 to 50 wt %, or, in some cases, 10 to 20 wt %, of polyether polyamines according to the formula wherein z has an average value of 6.1.

Examples of blends of polyetheraspartic esters that are suitable for use in the present invention are Desmophen NH 1720 (previously Desmophen NH2850XP) and Desmophen NH 1723 LF, from Covestro, which both have an equivalent weight of about 290-295 g mol⁻¹, a viscosity at 25° C. of >80 mPa·s, and an amine value between 170-210 mg KOH/g.

In one embodiment of the invention, the first component a) in the LEP coating composition (B) further comprises an aldimine.

Any suitable aldimine may be used and includes those prepared from an aldehyde and polyamines containing two or more, preferably 2 to 6 and more preferably 2 to 4, primary amino groups. The polyamines include high molecular weight amines having molecular weights in g mol⁻¹ of 400 to about 10,000, preferably 800 to about 6,000, and low molecular weight amines having molecular weights below 400. Examples of these polyamines are those wherein the amino groups are attached to aliphatic, cycloaliphatic, araliphatic and/or aromatic carbon atoms.

Suitable low molecular weight polyamines starting compounds include tetramethylene diamine, ethylene diamine, 1,2- and 1,3-propane diamine, 2-methyl-1,2-propane diamine, 2,2-dimethyl-1,3-propane diamine, 1,3- and 1,4-butane diamine, 1,3- and 1,5-pentane diamine, 2-methyl-1,5-pentane diamine, 1,6-hexane diamine, 1,7-heptane diamine, 1,8-octane diamine, 1,9-nonane diamine, 1,10-decane diamine, 1,11-dodecane diamine, 1-amino-3-aminomethyl-3,5,5-trimethyl cyclohexane, 4,4′-, 2,4′- and 2,2′-diamino dicyclohexyl methane, bis-(4-amino-3-methylcyclohexyl)-methane, 1,2- and/or 1,4-cyclohexane diamine, 1,3-bis(methylamino)-cyclohexane, 1,8-p-menthane diamine, hydrazine, hydrazides of semi-carbazido carboxylic acids, bis-hydrazides, bis-semicarbazides, phenylene diamine, 2,4- and/or 2,6-toluylene diamine, 2,3- and/or 3,4-toluylene diamine, polyphenylene polymethylene polyamines of the kind obtained by the aniline/formaldehyde condensation reaction, N,N,N-tris-(2-aminoethyl)-amine, guanidine, melamine, N-(2-aminoethyl)-1,3-propane diamine, 3,3′-diamino-benzidine, polyoxypropylene amines, polyoxyethylene amines, 2,4-bis-(4′-amino-benzyl)-aniline and mixtures thereof.

Preferred polyamines are 1-amino-3-aminomethyl-3,5,5-trimethyl-cyclohexane (isophorone diamine or IPDA), 4,4′-, 2,4′- and 2,2′-diamino dicyclohexyl methane, bis-(4-amino-3-methylcyclohexyl)-methane, 1,6-diaminohexane, 2-methyl pentamethylene diamine and ethylene diamine. 4,4′-diamino-dicyclohexyl-methane, optionally in a mixture with its isomers, is especially preferred.

Suitable high molecular weight polyamines correspond to the polyhydroxyl compounds as defined hereinbelow which are used to prepare the NCO prepolymers with the exception that the terminal hydroxy groups are converted to amino groups, either by amination or by reacting the hydroxy groups with a diisocyanate and subsequently hydrolyzing the terminal isocyanate group to an amino group. Preferred high molecular weight polyamines are amine-terminated polyethers such as the Jeffamine resins available from Texaco.

Suitable aldehydes are those corresponding to the formula O═CHCH(R₁) (R₂) wherein R₁ and R₂ may be the same or different and represent hydrocarbon radicals, preferably containing 1 to 10, more preferably 1 to 6, carbon atoms, or R₁ and R₂ together with the β-carbon atom form a cycloaliphatic ring.

Examples of suitable aldehydes include isobutyraldehyde, 2-ethyl hexanal, 2-methyl butyraldehyde, 2-ethyl butyraldehyde, 2-methyl valeraldehyde, 2,3-dimethyl valeraldehyde, 2-methyl undecanal and cyclohexane carboxyaldehyde.

The aldimines may be prepared in a known manner by reacting the polyamines with the aldehydes either in stoichiometric amounts or with an excess of aldehyde. The excess aldehyde and the water which is produced can be removed by distillation. The reactions may also be carried out in solvents, other than ketones. The solvents may also be removed by distillation after completion of the reaction.

A particularly preferred aldimine is an isophoranediamine aldimine, for example as Vestamin A-139 from Evonik.

The aldimine may be present in an amount of 3 to 30 wt %, preferably 5 to 20 wt %, relative to the total weight of the at least one polymer of component a) and the aldimine combined.

It will be appreciated that in the presence of moisture, aldimines are unstable, and they may be stored as a third component to maintain functionality. To maintain the aldimine functionality it is possible also to use moisture scavengers such as molecular sieves, oxazolidines, p-Toluenesulfonyl Isocyanate, etc.

The first component comprises at least one polymer selected from the group consisting of polyols, polyaspartic esters, polyetheraspartic esters and mixtures thereof. Such polymers may form at least 30 wt % of the component a), such as at least 50 wt % of component (a). Such polymers may form 30 to 60 wt % of the component a).

### Second Component b)

The second component b) of the LEP coating composition (B) comprises at least one polyisocyanate curing agent.

Suitable polyisocyanate curing agents are well known in the art. Examples of suitable low molecular weight polyisocyanates, having a molecular weight of 168 to 300 g mol⁻¹, include: hexamethylene diisocyanate (HDI), 2,2,4- and/or 2,4,4-trimethyl-1,6-hexamethylene diisocyanate, dodecamethylene diisocyanate, 2,4-diisocyanato-1-methyl-benzene (toluene diisocyanate, TDI), 2,4-diisocyanato-1-methylbenzene, 1,4-diisocyanatocyclohexane, 1-isocyanato-3,3,5-trimethyl-5-isocyanatomethylcyclohexane (IPDI), 1,5-pentamethylene diisocyanate (PDI), 2,4′-and/or 4,4′-diisocyanato-dicyclohexyl methane, 2,4- and/or 4,4′-diisocyanato-diphenyl methane and mixtures of these isomers with their higher homologues which are obtained in a known manner by the phosgenation of aniline/formaldehyde condensates, 2,4- and/or 2,6-diisocyanatotoluene, and any mixture of these compounds.

In some preferred LEP coating compositions of the present invention the polyisocyanate curing agent is selected from aliphatic polyisocyanates, e.g. HDI, 2,2,4- and/or 2,4,4-trimethyl-1,6-hexamethylene diisocyanate, dodecamethylene diisocyanate, 1,4-diisocyanatocyclohexane, IPDI, 2,4′- and/or 4,4′-diisocyanato-dicyclohexyl methane, and 2,4- and/or 4,4′-diisocyanato-diphenyl methane.

In preferred LEP coating compositions of the present invention the polyisocyanate curing agent is a derivative of the above-mentioned monomeric polyisocyanates, as is conventional in the art. These derivatives include polyisocyanates containing trimers or biuret groups. Examples of particularly preferred derivatives include N,N,N″-tris-(6-isocyanatohexyl)-biuret and mixtures thereof with its higher homologues and N,N′,N″-tris-(6-isocyanatohexyl)-isocyanurate and mixtures thereof with its higher homologues containing more than one isocyanurate ring.

Polyisocyanates for use in the invention can be purchased commercially. Commercial suppliers include Covestro, BASF, Asahi Kasei, Wanhua, and Vencorex, and suitable polyisocyanates (iii) are sold under trade names such as Desmodur, Duranate, Tolonate, Wannate, and Basonate

Isocyanate group-containing prepolymers and semi-prepolymers based on the monomeric polyisocyanates mentioned above, and organic polyhydroxyl or amine compounds, are also preferred for use as the polyisocyanate curing agent.

These prepolymers and semi prepolymers generally have an isocyanate content of 0.5-30 wt %, preferably 1-20 wt %, and are prepared in a known manner by the reaction of the above-mentioned starting materials (monomeric polyisocyanates and organic polyhydroxyl or amine compounds) at an NCO/OH equivalent ratio of 1.05:1 to 10:1 preferably 1.1:1 to 3:1, this reaction being optionally followed by distillative removal of any unreacted volatile starting polyisocyanates still present.

The prepolymers and semi prepolymers may be prepared from polyhydroxyl compounds having a molecular weight of 50 to 3000 g mol⁻¹. Examples include ethylene glycol, propylene glycol, trimethylol propane, 1,6-dihydroxy hexane; low molecular weight, hydroxyl-containing esters of these polyols with dicarboxylic acids of the type exemplified hereinafter; low molecular weight ethoxylation and/or propoxylation products of these polyols; and mixtures of the afore-mentioned polyvalent modified or unmodified alcohols.

Preferably the prepolymers and semi prepolymers are prepared from relatively high molecular weight polyhydroxyl compounds. These polyhydroxyl compounds have at least two hydroxyl groups per molecule (preferably two) and more preferably have a hydroxyl group content of 0.5-17 wt %, preferably 1-10 wt %.

Commercially available isocyanate prepolymers are available, for example, from Covestro under the trade name Desmodur, from Lanxess under the trade name Adiprene® or Trixene®, from Anderson Development Company under the trade name ANDUR or from COIM group under the trade name Versathane.

In a particularly preferable embodiment, the polyisocyanate curing agent comprises a mixture of a polyisocyanate prepolymer and a polyisocyanate trimer, such as an IPDI trimer.

The at least one polyisocyanate curing agent is preferably present in an amount of 80 to 100 wt %, preferably 85 to 100 wt %, such as 90 to 100 wt % relative to the total weight of the second component b). Thus component b) may consist of polyisocyanate curing agent.

The weight ratio between the a) and b) components can vary depending on the nature of the components. A typical weight ratio is 1:3 to 3:1. It may be that the component b) is in excess.

In a most preferred embodiment, it is preferred the at least one polyol resin (i) is present in an amount of 10 to 90 wt %, preferably 30 to 80 wt %, more preferably 60-75 wt % relative to the dry weight of the tiecoat layer composition (A); the isocyanate compound (ii) is present in an amount of 10-90 wt %, preferably 20-80 wt %, more preferably 30 to 60 wt %, relative to the dry weight of the tiecoat composition (A);

the polyols, polyaspartic esters, polyetheraspartic esters and mixtures thereof form 30 to 60 wt % of the component a);
the second component b) consist of the at least one polyisocyanate curing agent; and
wherein the wt ratio of component a) to b) is 3:1 to 1:3.

### Other Components

The LEP coating composition (B) of the present invention may also include other substances commonly used in coating formulations such as extenders, pigments, matting agents, solvents and additives such as waxes, dyes, dispersants, wetting agents, defoamers, surfactants, adhesion promoters, light stabilisers, water scavengers and thixotropic agents.

In one particular embodiment, the LEP coating composition comprises an adhesion promoter. Examples of suitable adhesion promotors include alkoxy silanes such as Dynasylan AMEO, Dynasylan 1189, and Silquest A1524 (VPS 2101 from Evonik, 3-ureidopropyltrimethoxysilane) and NCO-alkoxysilane hybrids such as Desmodur® 2873.

Additives in total will typically form up to about 50 wt %, such as 25 wt %, e.g. up to 20 wt %, ideally up to 15 wt %, based on the total amount of the LEP coating composition as a whole. Additives might be present in as little as 1 wt % or less of the LEP coating composition.

Examples of extenders are minerals such as dolomite, plastorite, calcite, quartz, barite, magnesite, silica, nepheline syenite, wollastonite, talc, chlorite, mica, kaolin, pyrophyllite and feldspar; synthetic inorganic compounds such as calcium carbonate, magnesium carbonate, barium sulphate, calcium silicate and silica;

polymeric and inorganic microspheres such as uncoated or coated hollow and solid glass beads, uncoated or coated hollow and solid ceramic beads, porous and compact beads of polymeric materials such as poly(methyl methacrylate), poly(methyl methacrylate-co-ethylene glycol dimethacrylate), poly(styrene-co-ethylene glycol dimethacrylate), poly(styrene-co-divinylbenzene), polystyrene, poly(vinyl chloride). Pigments of interest include organic pigments and inorganic pigments such as titanium dioxide.

Preferable examples of suitable solvents are organic solvents such as toluene, xylene and naphtha solvent; ketones such as methyl ethyl ketone, methyl isobutyl ketone, diacetone alcohol and cyclohexanone; esters such as methoxypropyl acetate, n-butyl acetate and 2-ethoxyethyl acetate; and mixtures thereof. Particularly preferred solvents are esters such as n-butyl acetate, t-butyl acetate, 1-methoxy-2-propyl acetate, most preferred n-butyl acetate and/or 1-methoxy-2-propyl acetate.

Solvent preferably forms less than 20 wt % of the LEP coating composition

(B). It will be appreciated that the wt % ranges for the solvent are relative to the weight of the LEP coating composition (B) as a whole before curing (i.e. before the coating is cured and dried). Any pigments preferably make up 10 to 30 wt %, e.g. 15 to 25 wt %, relative to the total weight of the LEP coating composition (B) as a whole. Extenders typically preferably make up 0 to 40 wt %, preferably 2.5 to 30 wt %, e.g. 5 to 20 wt %, relative to the total weight of the LEP coating composition (B) as a whole.

### Coating System and Application

In a preferred embodiment, the coating system of the invention is curable at ambient temperature, preferably room temperature, i.e. when the components are mixed, the tiecoat composition (A) and/or the LEP coating composition (B) will cure at the temperature in the environment in question without the application of heat. That might typically be in the range of 5 to 50° C. Preferably, curing occurs at 10 to 35° C., more preferably at room temperature, i.e. in the range 15 to 30° C. It will be understood that since the coating systems of the invention are curable they may be referred to as curable coating systems.

The coating system is preferably made up of several coating layers. Each of the layers are preferably made of several parts (e.g. two or more parts) to prevent premature curing and hence is shipped as a kit of parts.

The coating systems of the invention may be utilised to coat a substrate.

Suitable substrates include aircraft wings, wind turbine blades, rotor blades, propellers, radomes, antennae, fan blade nose cones and high speed vehicles such as trains or aircraft. Preferably, the substrate is selected from the group consisting of aircraft wings, wind turbine blades, rotor blades, propellers and fan blade nose cones.

In a particularly preferred embodiment, the substrate is a wind turbine blade. Typical turbine blades are composed of a material comprising a synthetic resin composite comprising an epoxy resin, a vinyl ester resin, glass or a carbon fiber reinforced resin. In a particularly preferred embodiment, the substrate is a leading edge of a wind turbine blade.

Thus, in a further aspect, the invention relates to a substrate which is at least partly coated with the coating system as hereinbefore defined. The invention also relates to the use of a coating system as hereinbefore defined for coating at least part of a substrate, wherein the substrate is preferably a wind turbine blade, more preferably the leading edge of a wind turbine blade.

The coating system can be applied by any conventional method such as brushing, rolling or spraying (airless or conventional). Preferably, conventional spraying is used.

The invention further relates to a process for coating at least part of a substrate with a coating system as hereinbefore defined, said process comprising applying the tiecoat composition (A) to the surface of said substrate and allowing said composition (A) to cure, and subsequently applying the LEP coating composition (B) directly on top of said composition (A), and allowing said composition (B) to cure.

Typically, the interval between applying the tiecoat composition and the LEP coating composition is less than 24 hrs, preferably in the range 1 to 24 hrs, more preferably 1 to 12 hrs, such as 1 to 6 hrs, at 23° C. and 50% relative humidity.

As stated above, the term “tiecoat” in the context of the invention means a layer of coating which acts as a bridge between, for example, a substrate, a primer or undercoat layer or a filler and a LEP coating layer. It will thus be understood that, when we refer to the “substrate” or “surface of a substrate”, we mean the substrate itself or any pre-treatment layers which have been applied to at least part of the substrate. Thus, the coating system of the invention may be applied directly to at least part of a substrate, or onto any pre-treatment layers designed for polyol, polyamine, polyaspartic ester or polyetheraspartic ester based polyurethane or polyurea topcoats.

In a preferred embodiment, the coating system of the invention is applied as part of the following coating system: an optional filler layer (typically also referred to as a putty, e.g. polyurethane with a high extender content), a primer layer (e.g. polyurethane or polyurea), a tiecoat layer and a LEP coating layer, in that order, wherein the coating system of the invention forms the tiecoat and LEP coating layers. Sometimes the LEP coating layer may be coated with another coating, but most often the LEP coating layer is the outermost coating layer in the coating system. Preferably, the primer is a waterbased, solvent based or solvent free polyurethane or polyaspartic coating. Preferably the filler is a polyurethane coating with a high solid content, preferably 80-100 wt % solids, typically more than 97 wt % solids.

It is preferred if the compositions (A) and (B) in the coating systems of the invention are transported in kits, preferably with the first and second components of each composition (A) and (B) kept separate from each other to prevent curing taking place prior to application to the desired surface. The components should be combined and thoroughly mixed before use. Conventional mixing techniques can be used.

The layers formed using the coating system of the invention preferably have a dry film thickness as follows: filler (0-2000 μm applied over 0-3 coats), primer (60-150 μm applied over 1-2 coats), tiecoat (20-50 μm applied over 1 coat), LEP coat (150-500 μm applied over 2-6 coats). It will be appreciated that any layer can be laid down using single or multiple applications of the coating depending on application method and area of use.

The invention will now be described with reference to the following non-limiting examples.

### Examples

### General Procedure for Preparation of the Compositions and Coated Substrates

The two components for various tiecoat compositions (IE=inventive example, according to the invention; CE=comparative example) were prepared by combining the respective constituents and homogeneously mixing them in a dissolver. For each composition, the two components were homogeneously mixed in the proportions indicated in Table 1/2. Immediately after preparation, the tiecoat compositions were applied (brush application).

The tie coat compositions were applied to a GRP test specimen or a GRP test specimen already coated with a commercially available 2K polyurethane-based primer. The coatings were allowed to dry for 2 hrs before the LEP coats were applied. The dry film thickness of the cured coating was 20 to 40 μm.

Similarly the LEP coatings were prepared (LEP coating composition given in the table below) and applied on top of the tie coats. Typically curing took place by storage at 23° C. for 2 weeks. The coatings were applied in two layers with brush (2×150 μm dry film thickness) with 2-3 hrs drying in between each coat. The total dry film thickness of the cured coating was 300 μm.

### Test Methods

### Adhesion:

Adhesion was tested with the Cross-hatch method according to ASTM D 6677 but using the ratings shown below:

| Rating | Description |
|---|---|
| 0 | Coating is extremely difficult to remove; fragments no larger than |
| | approx. 0.8 × 0.8 mm removed with great difficulty |
| 1 | Coating is difficult to remove; chips ranging from approx. 1.6 × 1.6 mm |
| | to 3.2 × 3.2 mm can be removed with difficulty |
| 2 | Coating is somewhat difficult to remove; chips ranging from approx. |
| | 3.2 × 3.2 mm to 6.3 by 6.3 mm can be removed with slight difficulty |
| 3 | Coating is somewhat difficult to remove; chips in excess of 6.3 × 6.3 mm |
| | can be removed by exerting light pressure with a knife blade. |
| 4 | Coating is easily removed; once started with the knife blade, the coating |
| | can be grasped with ones fingers and easily peeled to a length of at least |
| | 6.3 mm |
| 5 | Coatings can be easily peeled from the substrate to a length greater than |
| | 6.3 mm |

Two different systems were tested:
1: GRP+Tiecoat+LEP coat
2: GRP+Primer+Tiecoat+LEP coat

The adhesion results for these two systems are indicated as Adhesion (1) or Adhesion (2), respectively. Results for adhesion testing are shown in Table 1/2.

### Materials

| | Description |
|---|---|
| Resin 1 | BADGE resin (2000-3500 EEW, Mₙ = >3,500 g mol⁻¹, Type 8, |
| | 311-299 OHEW) |
| Resin 2 | BADGE resin (2500-3100 EEW, Mₙ = >3,500 g mol⁻¹, Type 9, |
| | 305-301 OHEW) |
| Resin 3 | BADGE resin (2500-4000 EEW, Mₙ = >3,500 g mol⁻¹, Type 9, |
| | 305-297 OHEW) |
| Resin 4 | BADGE resin (average 3300 EEW, Mₙ = >3,500 g mol⁻¹, Type 9, |
| | 300 OHEW) |
| Resin 5 | BADGE resin (3500-5500 EEW, Mₙ = >3,500 g mol⁻¹, Type 9, |
| | 299-293 OHEW) |
| Resin 6 | Alnovol PN 320/PAST, Mₙ <1,500 g mol⁻¹, a non-self-curing |
| | phenol novolac. |
| Resin 7 | Alnovol PN 760/PAST, Mₙ <1,500 g mol⁻¹, a functionalized |
| | phenol novolac resin. |
| Resin 8 | Novolac phenolic resin (Mₙ >10,000 g mol⁻¹) |
| Resin 9 | BADGE resin (475-550 EEW, Mₙ <1,000 g mol⁻¹, Type 1-2, 443- |
| | 412 OHEW) |
| Resin 10 | BADGE resin (1400-1600 EEW, Mₙ = 2,300 g mol⁻¹, Type 6, 324- |
| | 318 OHEW) |
| Resin 11 | BADGE resin (1750-1950 EEW, Mₙ = 2,800 g mol⁻¹, Type 7, 315- |
| | 312 OHEW) |
| Isocyanate | Aromatic NCO based on diphenylmethane diisocyanate, 100% wt |
| 1 | solids, 31.5 wt % NCO on total |
| Isocyanate | Aromatic NCO based on toluene diisocyanate, 75 wt % solids in |
| 2 | ethyl acetate, 13.3 wt % NCO on total |
| Isocyanate | Aliphatic HDI trimer, 90% wt solids in BA, 19.6 wt % NCO on |
| 3 | total |
| Adhesion | Silane-functional aliphatic polyisocyanate based on hexamethylene |
| promotor | diisocyanate, 100 wt % solids, 12.3 wt % NCO on total |

OHEW (OH equivalent weight) given are approximate numbers calculated from the EEW values and assuming all repeating units are BADGE.

The LEP coating composition used is as follows:

| | Quantity |
|---|---|
| | [wt %] |
| Component a | |
| Aspartic ester: | |
| Desmophen NH 1420, polyaspartic ester | 24.2 |
| having an amine value of 199-203 mg KOH/g | |
| Desmophen NH 1720 | 24.2 |
| a blend of polyetheraspartic esters having | |
| an amine value of 195 mg KOH/g | |
| Additives | 5.3 |
| HALS UV stabilizer and UV absorber | 3.2 |
| Extenders | 14.6 |
| Pigments | 26.9 |
| Solvent, PMA glycol ether | 1.6 |
| Total component a | 100 |
| PVC component a | 18.8 |
| Component b (curing component) | |
| Desmodur Z4470 BA | 22.2 |
| Aliphatic polyisocyanate (IPDI trimer) | |
| Desmodur E 40480 MPA (previously XP 2406) | 177.8 |
| Aliphatic polyisocyanate prepolymer based on isophorone | |
| diisocyanate; NCO-terminated polycarbonate modified IPDI | |
| prepolymer, NCO content is approx. 2.8 wt % on supply form (80 | |
| wt % solid content in methoxypropyl acetate). ~2 NCO | |
| functionalities per polymer. | |
| Total component b | 200 |

TABLE 1
Tiecoat compositions by weight and results from adhesion testing after coating with LEP coating composition

| | IE1 | IE2 | IE3 | IE4 | IE5 | IE6 | IE7 | IE8 | IE9 | IE10 | IE11 | IE12 | IE13 |
|---|---|---|---|---|---|---|---|---|---|---|---|---|---|
| Comp (i) | | | | | | | | | | | | | |
| Resin 4 | | | | | | | | 31.5 | 31.5 | 31.5 | 31.5 | | 20.5 |
| Resin 1 | 31.5 | | | | | | | | | | | | |
| Resin 5 | | 31.5 | | | | | | | | | | | |
| Resin 3 | | | 31.5 | 31.5 | | | | | | | | | |
| Resin 6 | | | | | 11.0 | | | | | | | | |
| Resin 7 | | | | | | 11.0 | | | | | | | |
| Resin 2 | | | | | | | | | | | | 31.5 | |
| Resin 8 | | | | | | | 11.0 | | | | | | |
| Resin 9 | | | | | | | | | | | | | |
| Resin 10 | | | | | | | | | | | | | |
| Resin 11 | | | | | | | | | | | | | |
| Butyl acetate | | | | | 89 | 89 | | | | | | | |
| Pigments | | | | | | | | | | | | | 35 |
| PMA glycol ether | 31.5 | 31.5 | 31.5 | 31.5 | | | | 31.5 | 31.5 | 31.5 | 31.5 | 31.5 | 20.5 |
| Xylene | 37 | 37 | 37 | 37 | | | | 37 | 37 | 37 | 37 | 37 | 24 |
| MIBK | | | | | | | 89 | | | | | | |
| Comp (ii) | | | | | | | | | | | | | |
| Isocyanate 1 | | | | | 4.0 | 4.0 | 4.0 | | | 10.9 | | | |
| Isocyanate 2 | 25.7 | 25.7 | 25.7 | 19.2 | | | | 19.2 | 25.6 | | | 25.7 | 16.7 |
| Adhesion promotor | | | | 6.9 | | | | 6.9 | 6.4 | | | | |
| Isocyanate 3 | | | | | | | | | | | 17.4 | | |
| Butyl acetate | | | | | 6 | 6 | 6 | | | | 3.5 | | |
| NCO:OH ratio | 0.78:1 | 0.76:1 | 0.77:1 | 0.77:1 | | | | 0.77:1 | 0.95:1 | 0.77:1 | 0.77:1 | 0.78:1 | 0.77:1 |
| Adhesion (1) | 1 | 1 | 1 | 1 | 2 | 1 | 0-1 | 0-1 | 1 | 1 | 2 | 2 | 1 |
| Adhesion (2) | 1 | 1 | 1 | 1 | 2 | 4 | 0-1 | 0 | 0 | 1 | 2 | 2 | 2 |

TABLE 2
Comparative examples

| | CE1 | CE2 | CE3 | CE4 | CE5 |
|---|---|---|---|---|---|
| Comp (i) | | | | | |
| Resin 3 | 31.5 | | | | |
| Resin 9 | | | 31.5 | | |
| Resin 10 | | | | 31.5 | |
| Resin 11 | | | | | 31.5 |
| Butyl acetate | | | | | |
| Pigments | | | | | |
| PMA glycol ether | 31.5 | | 31.5 | 31.5 | 31.5 |
| Xylene | 37 | | 37 | 37 | 37 |
| Comp (ii) | | | | | |
| Isocyanate 2 | | 100 | 25.7 | 25.7 | 25.7 |
| NCO:OH ratio | N/A | N/A | 1.1:1 | 0.83:1 | 0.81:1 |
| Adhesion (1) | 5 | 5 | 3 | 5 | 4 |
| Adhesion (2) | 5 | 5 | 5 | 5 | 5 |

The comparative examples 3-5 with lower Mn epoxy resins offer poorer adhesion. CE1, with no component (ii) and CE2 with no component (i) also offer poor adhesion.

### Rain Erosion Test

Rain erosion testing was carried out following standard ASTM G73-10, where GRP panels of airfoil shape, the length of exposure zone of panel for droplet impact is 23 cm, were coated with the coating systems given in Table 3. A coated test panel was attached to each of the three rotor arms, and testing carried out at 1527 rpm=160 m s⁻¹, 15-35° C., rain intensity 30-35 mm h⁻¹, and inspected every 30 min to monitor visually the erosion of the coating systems. In order for the coating system to pass the test it should have minimal or no visual damages or delamination of the coatings of the test subject after being exposed for 3 hrs. High performance coating systems have no visible damages or delamination to/of the coating system after 3 hrs exposure.

TABLE 3
RET results after 3 hrs exposure for GRP samples
coating with topcoat, tiecoat and LEP.

| | System 1 (comparative | System 2 |
|---|---|---|
| | example) | (inventive example) |
| Tiecoat | — | IE3 |
| LEP | LEP | LEP |
| RESULT | FAIL, serious delamination | PASS, no delamination |

Including a tiecoat in the coating system is seen to significantly improve rain erosion performance.

1. A coating system comprising at least two layers A and B, wherein said layers A and B are adjacent and wherein layer A comprises:
(A) A tiecoat composition comprising:
(i) A first component comprising at least one polyol resin; and
(ii) A second component comprising an isocyanate compound; and
wherein layer B comprises:
(B) A leading edge protection (LEP) coating composition comprising:
a) a first component comprising at least one polymer selected from the group consisting of polyols, polyaspartic esters, polyetheraspartic esters and mixtures thereof; and
b) a second component comprising at least one polyisocyanate curing agent.

2. A coating system comprising at least two layers A and B, wherein said layers A and B are adjacent and wherein layer A comprises:
(A) A tiecoat composition comprising:
(i) A first component comprising at least one polyol resin; and
(ii) A second component comprising an isocyanate compound,
wherein the first and second components have been mixed and cured; and
wherein layer B comprises:
(B) A leading edge protection (LEP) composition comprising:
a) a first component comprising at least one polymer selected from the group consisting of polyols, polyaspartic esters, polyetheraspartic esters and mixtures thereof; and
b) a second component comprising at least one polyisocyanate curing agent,
wherein the first and second components have been mixed and cured.

3. The coating system as claimed in claim 1 or 2, wherein the polyol resin (i) in (A) is an epoxy resin, preferably an epoxy resin with an epoxy equivalent weight (EEW) of 1100-7000 g eq⁻¹, preferably 2000-5000 g eq⁻¹.

4. The coating system as claimed in claim 3, wherein the epoxy resin is a bisphenol A epoxy resin.

5. The coating system as claimed in claim 3 or 4, wherein the epoxy resin is an Epoxy type 8 resin or an Epoxy type 9 resin, preferably an Epoxy type 9 resin.

6. The coating system as claimed in claim 1 or 2, wherein the polyol resin (i) in (A) is a phenol formaldehyde resin, preferably a novolac resin.

7. The coating system as claimed in any of claims 1 to 6, wherein the number average molecular mass (Mn) molecular weight of the polyol resin (i) in (A) is at least 1500 g mol⁻¹, preferably at least 2000 g mol⁻¹, more preferably at least 3500 g mol⁻¹.

8. The coating system as claimed in any of claims 1 to 7, wherein the isocyanate compound (ii) in (A) comprises a polyisocyanate, preferably an aromatic polyisocyanate.

9. The coating system as claimed in any of claims 1 to 8, wherein the at least one polyol resin (i) is present in an amount of 10 to 90 wt %, preferably 30 to 80 wt %, more preferably 60-75 wt % relative to the dry weight of the tiecoat layer composition (A).

10. The coating system as claimed in any of claims 1 to 9, wherein the isocyanate compound (ii) is present in an amount of 10-90 wt %, preferably 20-80 wt %, more preferably 30 to 60 wt %, relative to the dry weight of the tiecoat composition (A).

11. The coating system as claimed in any of claims 1 to 5 or 7 to 10, wherein the NCO to amine and hydroxyl (NH+OH) ratio or NCO to hydroxyl ratio based on moles of the total tiecoat composition (A) is 0.4-1.1, preferably 0.6-1.0, more preferably 0.7-0.9, even more preferably 0.8.

12. The coating system as claimed in any of claims 1 to 11, wherein the at least one polyisocyanate curing agent b) in (B) is a polyisocyanate prepolymer or a mixture of a polyisocyanate prepolymer and a polyisocyanate trimer.

13. The coating system as claimed in any of claims 1 to 12, wherein the first component a) in the LEP coating composition (B) further comprises an aldimine.

14. The coating system as claimed in any of claims 1 to 13, wherein the coating system comprises three layers X, A, B, in that order, wherein layers A and B are as defined in any proceeding claim and layer X is a polyaspartic or polyurethane layer.

15. The coating system as claimed in any preceding claim wherein the polyol resin in (A) is:
an epoxy resin, such as a bisphenol A epoxy resin, wherein the number average molecular mass (Mn) of the epoxy resin as polyol resin (i) in (A) is at least 3000 g mol⁻¹, preferably at least 3500 g mol⁻¹; or
the polyol resin is a phenol formaldehyde resin, preferably a novolac resin.

16. The coating system as claimed in any preceding claim wherein the at least one polyol resin (i) is present in an amount of 10 to 90 wt %, preferably 30 to 80 wt %, more preferably 60-75 wt % relative to the dry weight of the tiecoat layer composition (A);
the isocyanate compound (ii) is present in an amount of 10-90 wt %, preferably 20-80 wt %, more preferably 30 to 60 wt %, relative to the dry weight of the tiecoat composition (A);
the polyols, polyaspartic esters, polyetheraspartic esters and mixtures thereof form 30 to 60 wt % of the component a);
the second component b) consist of the at least one polyisocyanate curing agent; and
wherein the wt ratio of component a) to b) is 3:1 to 1:3.

17. A substrate at least partly coated with the coating system as defined in any of claims 1 to 16.

18. The substrate as claimed in claim 17, wherein said substrate is a wind turbine blade, preferably the leading edge of a wind turbine blade.

19. Use of a coating system as defined in any of claims 1 to 16 for coating at least part of a substrate, wherein the substrate is preferably wind turbine blades, more preferably the leading edge of a wind turbine blade.

20. A process for coating at least part of a substrate with a coating system as defined in any of claims 1 to 16, said process comprising applying the tiecoat composition (A) to the surface of said substrate and allowing said composition (A) to cure, and subsequently applying the LEP coating composition (B) directly on top of said composition (A), and allowing said composition (B) to cure.
